(19) United States
(12) Patent Application Publication
(10) Pub. No.: US 2004/0083202 A1
(43) Pub. Date: Apr. 29, 2004

(54) Techniques to control recalls in storage management applications

(75) Inventors: Yuedong Mu, San Jose, CA (US); Albert Leung, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arkivio, Inc., Mountain View, CA

(21) Appl. No.: 10/232,671

(22) Filed: Aug. 30, 2002

(51) Int. Cl. G06F 7/00

(52) U.S. Cl. 707/3

(57) ABSTRACT

Techniques for reducing false recalls by controlling recalls performed by data migration applications in a storage environment comprising a plurality of storage units. According to an embodiment of the present invention, false recalls are reduced by restricting certain users, groups, and programs from performing recall or demigration of data. Techniques are provided that enable a storage system administrator to specify a list of users, groups, and programs for which data file recall is disallowed.

### BACKGROUND OF THE INVENTION

The present invention relates generally to the field of data storage and management, and more particularly to techniques for controlling recall or demigration of data upon data access such that unnecessary recalls (or false recalls) are avoided.

Data storage demands have grown dramatically as an increasing amount of data is now stored in digital form. These increasing storage demands have given rise to heterogeneous and complex storage environments comprising storage systems and devices with different cost, capacity, bandwidth, and other performance characteristics. Due to their heterogeneous nature, managing storage of data in such environments is a complex and costly task.

Several solutions have been designed to reduce costs associated with data storage management and to make efficient use of available storage resources. Several solutions have been developed which make efficient use of available storage resources by moving data from one device to another. One such solution is Hierarchical Storage Management (HSM) that provides access to data in a heterogeneous storage environment while reducing both the administrative and storage costs associated with the storage environment. HSM provides an automatic and transparent process of managing and distributing data between different storage devices to meet user needs while reducing overall management costs.

HSM applications are capable of moving data along a hierarchy of storage devices. The storage devices may be ranked by a system administrator based upon cost per megabyte of storage, speed of storage and retrieval, and overall capacity limits. A storage administrator may set up rules and policies such that data files are moved or migrated along the hierarchy from expensive storage forms to less expensive forms of storage. These rules or policies may be based upon parameters such as frequency of data access, storage thresholds limits, age of a data file, and the like. In HSM, the administrator has to specify the data to be moved, the source storage device storing the data, and the target storage device for moving the data.

For example, a three-tier storage hierarchy may be composed of hard drives on file servers as primary storage, optical storage devices as secondary storage, and tapes as tertiary storage. Based upon policies configured by an administrator, less frequently used data may be migrated by HSM applications from hard drives to optical storage to free up the expensive primary storage data for more frequently used data. Likewise, data may be migrated from optical storage devices to tapes.

In HSM, when a data file is migrated from primary storage to some other storage, a stub file is left in the original location on the primary storage device. The stub file points the HSM application to the exact storage location of the migrated data in the storage hierarchy. The data file may be migrated again (or remigrated) from the other storage devices to yet other storage devices. The stub file continues to point the HSM application to the exact storage location of the migrated data in the storage hierarchy.

These stub files enable users and applications to access data files as though the files were still stored in the original location on the primary storage device. Accordingly, even though files are migrated from original storage locations on primary storage devices to other storage devices, to the user it appears as if they are stored on the primary storage device.

When a HSM application receives a request to access a particular data file, the HSM application uses the stub file to locate the particular data file and demigrates (or recalls) the requested data file from the remote storage device to the original storage location of the data file on the primary storage device. The particular file is then served to the user from the primary storage device.

Demigration or recall of a file can incur significant network traffic overhead. The recall also uses up primary storage device space and reduces the storage space available for other data. Conventional HSM and other data migration applications always demigrate a file in response to a request to access the file irrespective of whether the demigration is actually required. For example, if an application issues a data request in order to determine ownership information for a particular file, the particular file is demigrated to the original storage location on the primary storage device even though access to the file contents is not required to determine ownership attributes of the file. Another example when unintentional or false recalls are performed is when anti-virus software scans files in the system.

These unintentional or false recalls “thrash” the primary storage resources as excess capacity and excess network bandwidth to transfer the migrated data is required to store recalled or demigrated data, making the system unresponsive. Accordingly, conventional data migration applications lack the intelligence to perform selective recalls of data files.

Most operating systems support the concept of volumes which provide a logical view of the underlying storage devices. Each volume is identified by a unique identifier (e.g., a number, name, etc.) that allows it to be specified by a user. A single physical storage device may be divided into several separately identifiable volumes. A single volume may also span storage space provided by multiple physical storage devices.

A storage environment may comprise multiple servers, each coupled to one or more volumes. By using volumes, the physical storage devices and the distribution of data across the physical storage devices becomes transparent to servers and applications.

In case of volumes, a HSM application is configured to migrate a data file from an original volume where the data file is originally stored to another volume. When a data file is migrated from an original volume to another volume, a stub file is stored on the original volume that points the HSM application to the volume where the data file has been migrated. The data file may be remigrated to yet another volume. The stub file stored on the original volume continues to point the HSM application to the exact storage location of the remigrated data.

As described above, when a HSM application receives a request to access a particular data file, the HSM application uses the stub file to locate the particular data file and demigrates (or recalls) the requested data file from the remote volume to the original volume. Demigration incurs the overheads described above.

Accordingly, techniques are desired for controlling recalls performed by automated data migration applications.

### BRIEF SUMMARY OF THE INVENTION

Embodiments of the present invention provide techniques for reducing false recalls by controlling recalls performed by data migration applications in a storage environment comprising a plurality of storage units. According to an embodiment of the present invention, false recalls are reduced by restricting certain users, groups, and programs from performing recall or demigration of data. Techniques are provided that enable a storage system administrator to specify a list of users, groups, and programs for which data file recall is disallowed.

According to an embodiment of the present invention, techniques are provided for controlling recall of data in a heterogeneous storage environment. In this embodiment, a signal is received to recall a data file, the signal generated in response to a request to access the data file received from a user. The embodiment of the present invention then determines if the user is permitted to recall the data file. The recall of the data file is disallowed if the user is not permitted to recall the data file.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a storage system that may incorporate an embodiment of the present invention;

FIG. 2 is a simplified block diagram of data processing system according to an embodiment of the present invention;

FIG. 3 is a simplified high-level flowchart depicting a method of controlling recalls according to an embodiment of the present invention; and

FIG. 4 is a simplified block diagram showing modules that may be used to implement an embodiment of the present invention.

### DETAILED DESCRIPTION OF THE INVENTION

Embodiments of the present invention provide techniques for reducing false recalls by controlling recalls performed by data migration applications in a storage environment comprising a plurality of storage units. According to an embodiment of the present invention, false recalls are reduced by restricting certain users, groups, and programs from performing recall or demigration of data. Techniques are provided that enable a storage system administrator to specify a list of users, groups, and programs for which data file recall is disallowed.

For purposes of this application, the term “physical storage device” or “storage device” is intended to refer to any physical system, subsystem, device, computer medium, network, or other like system or mechanism that is capable of storing data.

For purposes of this application, the term “physical storage unit” is intended to refer to a physical storage device. Examples of physical storage units include disk drives, tapes, hard drives, optical disks, RAID structures, solid state storage devices, and other types of computer-readable storage media.

For purposes of this application, the term “logical storage unit” is intended to refer to a virtual storage space such as a volume. A logical storage unit may span multiple physical storage units. A physical storage unit may be divided into multiple separately identifiable logical storage units.

For purposes of this application, the term “storage unit” is intended to refer to either a physical storage unit or a logical storage unit.

For purposes of this application, the term “original storage unit” is intended to refer to a storage unit, either physical or logical, on which a data file is originally stored. If the data file has been migrated or remigrated, the stub file corresponding to the data file is stored on the original storage unit.

For purposes of this application, the term “repository storage unit” is intended to refer to a storage unit, either physical or logical, on which the migrated or remigrated data file is stored. The repository storage unit may be connected to the same server as the original storage unit or may be connected to another server in the storage environment. The stub file stored on the original storage unit may store information identifying the repository storage unit.

For purposes of this application, the term “original data” is intended to refer to a block of data, blob of data, or file that is stored on an original storage unit and has not been migrated or remigrated. Original data may include one or more “original data files”. An “original data file” is a file that is stored on an original storage unit and has not been migrated or remigrated.

For purposes of this application, the term “migrated data” is intended to refer to a block of data, blob of data, or file that is stored on a repository storage unit and represents data that has been migrated or remigrated. Migrated data may include one or more “migrated data files”. A “migrated data file” is a file that is stored on a repository storage unit and represents data that has been migrated or remigrated.

For purposes of this application, the term “migration” is intended to refer to movement of an original data file from an original storage unit to a repository storage unit. For example, when a data file is moved from a primary physical storage unit to a secondary physical storage unit, or from an original logical storage unit to another logical storage unit.

For purposes of this application, the term “remigration” is intended to refer to movement of a migrated data file from a first repository storage unit where the migrated data file is stored to another repository storage unit. For example, when a data file is moved from a secondary physical storage unit to a tertiary physical storage unit, or from a first logical storage unit to another logical storage unit.

For purposes of this application, the term “recall” or “demigration” is intended to refer to movement of a migrated or remigrated data file from a repository storage unit to an original storage unit. The terms “recall” and “demigration” are synonymous to each other and are used interchangeably.

For purposes of this application, the term “program” is intended to refer to an application, a program, or a process executed by a data processing system.

While the present invention has been described with reference to a HSM application, it should be understood that the present invention can also be used with any automated data storage management application that moves data from one storage unit to another storage unit. Accordingly, the description below is merely illustrative of an embodiment of the present invention and is not intended to limit the scope of the present invention as recited in the claims. One of ordinary skill in the art would recognize other variations, modifications, and alternatives.

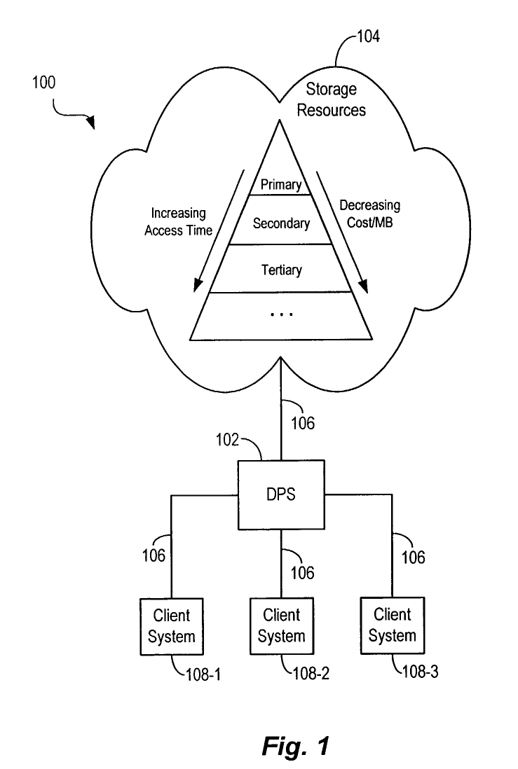

FIG. 1 is a simplified block diagram of a storage system 100 that may incorporate an embodiment of the present invention. Storage system 100 comprises a data processing system (DPS) 102 coupled to storage resources 104 via communication links 106. One or more client computers 108 may also be coupled to data processing system 102 via communication links 106. Storage system 100 depicted in FIG. 1 is merely illustrative of an embodiment incorporating the present invention and does not limit the scope of the invention as recited in the claims. One of ordinary skill in the art would recognize other variations, modifications, and alternatives.

Storage resources 104 provide resources for storing data. Storage resources 104 may include storage units with different cost, capacity, bandwidth, and other performance characteristics. Storage resources 104 may include one or more servers. One or more storage units may be coupled to each server. Storage resources 104 may include online devices, near-line devices, off-line devices, volumes, storage networks such as a storage area network (SAN), network attached storage (NAS), and the like.

Communication links 106 depicted in FIG. 1 may be of various types including hardwire links, optical links, satellite or other wireless communication links, wave propagation links, or any other mechanisms for communication of information and data. Various communication protocols may be used to facilitate communication of information via the communication links. These communication protocols may include TCP/IP, HTTP protocols, extensible markup language (XML), wireless application protocol (WAP), optical protocols, Fibre Channel protocols, protocols under development by industry standard organizations, vendor-specific protocols, customized protocols, and others.

Communication links 106 may traverse one or more communication networks. These communication networks may include a LAN, a wide area network (WAN), a metropolitan area network (MAN), a wireless network, an Intranet, the Internet, a private network, a public network, a switched network, an optical network, or any other suitable communication network.

According to an embodiment of the present invention, the storage units in storage resources 104 may be ranked according to or classified into a storage hierarchy comprising a plurality of storage levels. For example, these storage levels may include primary storage, secondary storage, tertiary storage, and the like. A storage unit may be classified as belonging to a particular hierarchical storage level based upon the cost (e.g., cost per megabyte) of storing data on the storage unit, data access speed of the storage unit, overall capacity of the storage unit, and other factors.

According to an embodiment of the present invention, the cost of storing data decreases with increasing storage hierarchy levels. For example, the cost of storing data on a secondary storage unit (i.e., a storage unit classified as belonging to the second storage hierarchy level) is less than the cost of storing data on a primary storage unit (i.e., a storage unit classified as belonging to the first or primary storage hierarchy level). The time to access data from a storage unit may also increase with increasing storage hierarchy levels. For example, the time taken to access data from a primary storage unit may be less than the time taken to access data from a secondary storage unit.

An exemplary three-tier storage hierarchy comprising physical storage units may be composed of hard drives on file servers as primary physical storage units, optical storage devices as secondary physical storage units, and tapes as tertiary physical storage units. Generally, an original data file is initially stored on a primary physical storage unit and then migrated to other physical storage units in other storage levels based upon rules or policies configured by a storage system administrator. As indicated above, in conventional HSM applications, in response to a data access request, the migrated data is demigrated or recalled back to the primary physical storage unit before the data is served to the user.

It should be understood that classifying storage units into a hierarchy is not essential to the present invention. A HSM application may be configured to migrate or remigrate data from one storage unit to another based upon policies specified by a user of storage system 100. The present invention applies to any application that moves data from a an original storage unit to another storage unit and the data is accessed via the original storage unit.

Data processing system 102 is configured to execute software applications and programs that are responsible for controlling storage of data in storage system 100, managing the data, and controlling access to the data. Data processing system 102 may also execute HSM applications and/or other automated data storage applications. According to an embodiment of the present invention, software modules and programs that provide the functionality of the present invention are also executed by data processing system 102. Databases and other information used by the present invention may be stored on data processing system 102 or in a storage location accessible to data processing system 102.

According to an embodiment of the present invention, data processing system 102 is configured to receive requests from data consumers to access data stored by the storage units in storage resources 104. For example, data processing system 102 may receive data access requests from one or more client systems 108. These data access requests may be configured by users of client systems 108 or may be received from programs executed by client systems 108. The term “client computer system” is intended to refer to any computer system that is a source of a data access request. These data access requests may trigger recall or demigration operations before the requested data is served in response to the request. According to the teachings of the present invention, modules executing on data processing system 102 are configured to determine if a recall operation is permitted and to perform the recall operation if permitted.

FIG. 1 depicts an embodiment in which processing according to the teachings of the present invention is performed by data processing system 102. It should be understood in alternative embodiments of the present invention the processing may be distributed among a plurality of data processing systems and servers. For example, software modules implementing an embodiment of the present invention may be spread across and executed by multiple servers. Accordingly, the embodiment depicted in FIG. 1 and the following description is not intended to limit the scope of the present invention.

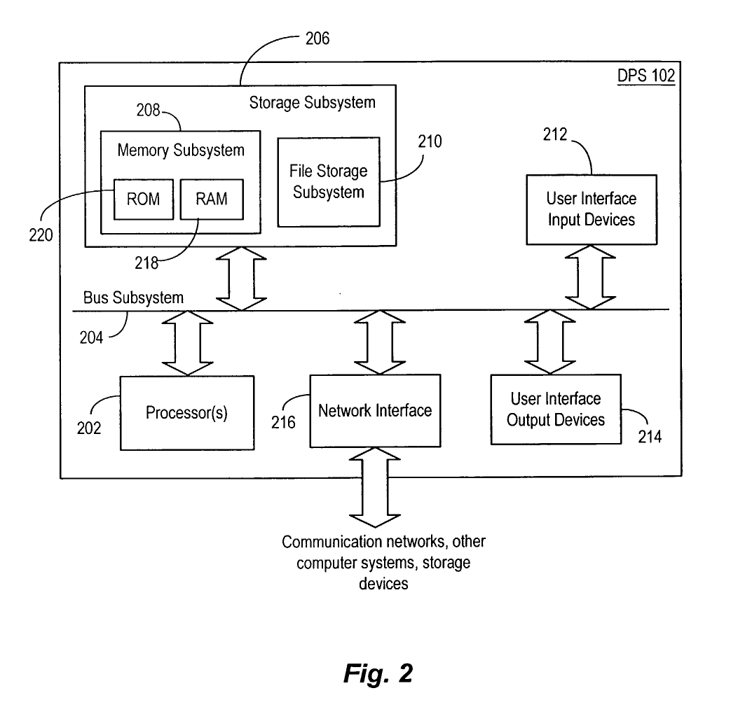

FIG. 2 is a simplified block diagram of data processing system 102 according to an embodiment of the present invention. As shown in FIG. 2, data processing system 102 includes at least one processor 202, which communicates with a number of peripheral devices via a bus subsystem 204. These peripheral devices may include a storage subsystem 206, comprising a memory subsystem 208 and a file storage subsystem 210, user interface input devices 212, user interface output devices 214, and a network interface subsystem 216. The input and output devices allow user interaction with data processing system 102.

Network interface subsystem 216 provides an interface to other computer systems, networks, and storage resources 104. Embodiments of network interface subsystem 216 include an Ethernet card, a modem (telephone, satellite, cable, ISDN, etc.), (asynchronous) digital subscriber line (DSL) units, and the like.

User interface input devices 212 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and ways to input information to data processing system 102.

User interface output devices 214 may include a display subsystem, a printer, a fax machine, or non-visual displays such as audio output devices. The display subsystem may be a cathode ray tube (CRT), a flat-panel device such as a liquid crystal display (LCD), or a projection device. In general, use of the term “output device” is intended to include all possible types of devices and ways to output information from data processing system 102.

Storage subsystem 206 may be configured to store the basic programming and data constructs that provide the functionality of the present invention. For example, according to an embodiment of the present invention, software modules implementing the functionality of the present invention may be stored in storage subsystem 206. These software modules may be executed by processor(s) 202. Storage subsystem 206 may also provide a repository for storing data input by a system administrator and various databases that are used to store information according to the teachings of the present invention. Software modules implementing automated data storage management applications (e.g., HSM applications) may also be stored in storage subsystem 206. Storage subsystem 206 may comprise memory subsystem 208 and file/disk storage subsystem 210.

Memory subsystem 208 may include a number of memories including a main random access memory (RAM) 218 for storage of instructions and data during program execution and a read only memory (ROM) 220 in which fixed instructions are stored. File storage subsystem 210 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Bus subsystem 204 provides a mechanism for letting the various components and subsystems of data processing system 102 communicate with each other as intended. Although bus subsystem 204 is shown schematically as a single bus, alternative embodiments of the bus subsystem may utilize multiple busses.

Data processing system 102 itself can be of varying types including a personal computer, a portable computer, a workstation, a network computer, a mainframe, a kiosk, or any other data processing system. Due to the ever-changing nature of computers and networks, the description of data processing system 102 depicted in FIG. 2 is intended only as a specific example for purposes of illustrating the preferred embodiment of the computer system. Many other configurations having more or fewer components than the system depicted in FIG. 2 are possible.

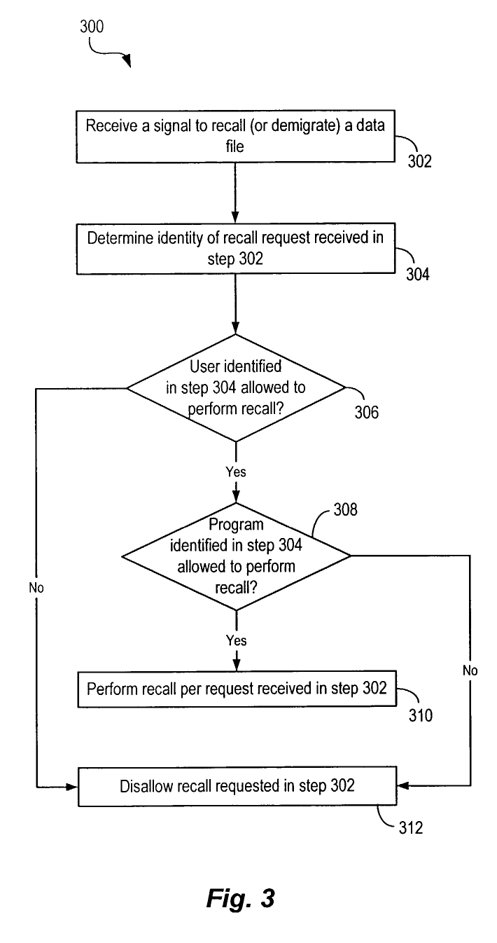

FIG. 3 is a simplified high-level flowchart 300 depicting a method of controlling recalls according to an embodiment of the present invention. The method depicted in FIG. 3 may be performed by data processing system 102, or by data processing system 102 in association with other data processing systems. The method may be performed by software modules executed by processor(s) 202 of data processing system 102, by hardware modules of data processing system 102, or combinations thereof. Flowchart 300 depicted in FIG. 3 is merely illustrative of an embodiment incorporating the present invention and does not limit the scope of the invention as recited in the claims. One of ordinary skill in the art would recognize variations, modifications, and alternatives.

As depicted in FIG. 3, processing is initiated when data processing system 102 receives a signal to recall a data file that has been migrated or remigrated (step 302). According to an embodiment of the present invention, the signal may be received by a software module executing on data processing system 102 that is responsible for controlling recalls.

The signal may be received from various sources. According to an embodiment of the present invention, the signal may be generated and received from a data storage management application (e.g., HSM a application) in response to a request to access the data file received by the data storage management application from a user/and or program. For example, the signal may be generated by a HSM application upon receiving a request to access a data file that has been migrated from an original storage unit to a repository storage unit. The HSM application may determine the actual storage location of the requested data file from a stub file corresponding to the data file stored on the original storage unit, and generate a signal to demigrate or recall the requested file from the repository storage unit back to the original storage unit before the data file can be served to the requesting user. The signal received in step 302 may also be triggered by other events related to management of data stored by the storage units.

The identity of the recall request received in step 302 is then determined (step 304). Processing in step 304 may involve determining the identity of a user who generated or caused the generation of the recall signal received in step 302. For example, in step 304, data processing system 102 may determine information identifying a user who was the source of the data access request that resulted in generation of the recall signal received in step 302. A user may be identified by a user name, user identifier, and the like.

As is well known, a user may belong to one or more user groups. The process of forming groups and assigning a user to one or more groups is well known in the art. The groups themselves may be hierarchically organized as is known to those skilled in the art. As part of step 304, the identity of one or more groups to which the user belongs may also be determined. If the groups are organized in a hierarchy, the hierarchy may be analyzed to identify one or more groups to which the user belongs. In certain embodiments, the inclusion or exclusion of a subgroup may have higher priority than the one of the parent group or any group up in the hierarchy.

As part of step 304, data processing system 102 may also determine the identity of a program that generated or caused the generation of the recall signal received in step 302. For example, in step 304, data processing system 102 may determine information identifying a program that was the source of the data access request that resulted in generation of the recall signal received in step 302. A program may be identified by a program name, program identifier, process name, process identifier, and the like. Other information related to the recall signal may also be determined in step 304.

Data processing system 102 then determines if the user identified in step 304 is allowed to perform the requested recall or demigration of data (step 306). Various different techniques may be provided to enable a storage system administrator to specify one or more users for whom recall should be disallowed. According to one technique, the system administrator may create an exclusion list that lists users for whom recall is disallowed. Users whose names (or user identifiers) appear in the exclusion list are not allowed to perform recall or to demigrate the data file. Alternatively, the system administrator may create an inclusion list that lists only those users who are allowed to perform a recall operation. Any user not included in the inclusion list is not allowed to perform the recall or demigration operation.

As part of step 306, data processing system 102 may also determine if the user belongs to any group that is not allowed to perform recall or demigration of data. A user may belong to one or more groups. Names of groups (or group identifiers) that are not permitted to perform recall may be included in an exclusion list. Alternatively, the system administrator may create an inclusion list that lists only those groups for whom recall is allowed. A group that is not listed in the inclusion list is not allowed to perform recall or demigration.

The groups themselves may be hierarchically organized as is known to those skilled in the art. As part of step 306, the group hierarchy may be analyzed to determine if the user belongs to any group that is not permitted to perform recall.

According to an embodiment of the present invention, a user is not allowed to perform recall if the user (either user name or user identifier) is listed in an exclusion list (or alternatively, not included in an inclusion list) or the user belongs to any group that is included in an exclusion list (or alternatively, not included in an inclusion list).

If it is determined in step 306 that the user is not permitted to perform recall or demigration of data, then the recall operation requested by the signal received in step 302 is not permitted, i.e., the recall operation is disallowed (step 312). A message may be output indicating the reason for disallowing the recall or demigration request.

If it is determined in step 306 that the user is permitted to perform recall or demigration of the data file, then data processing system 102 determines if the program or process (identified in step 304) that generated or caused the generation of the recall signal is allowed to perform a recall or demigration operation (step 308).

Various different techniques may be provided to enable a storage system administrator to specify programs for which recall should be disallowed. According to one technique, programs that are not allowed to perform recall are listed in an exclusion list. The programs may be identified using program or process names or identifiers. Alternatively, programs that are allowed to perform recall may be listed in an inclusion list. A process or program that is not listed in the inclusion list is not allowed to perform recall or demigration. According to an embodiment of the present invention, a program is not permitted to perform recall if the program is listed in an exclusion list (or alternatively, not included in an inclusion list).

If it is determined in step 308 that the program is not permitted to perform recall or demigration of data, then the recall operation requested by the signal received in step 302 is disallowed and not performed (step 312). A message may be output indicating the reason for disallowing the recall or demigration request.

If it is determined in step 308 that the program or process is permitted to perform recall or demigration of data, then the data file identified in step 302 is recalled or demigrated per the recall signal received in step 302 (step 310). As part of the recall operation the data file may be recalled or demigrated from a repository storage unit to the original storage unit. For example, the requested data file may be demigrated or recalled from a repository logical storage unit to an original logical storage unit, or from a physical storage unit belonging to secondary storage hierarchy level to the original physical storage unit belonging to a primary storage hierarchy level.

It should be understood that steps 306 and 308 may be performed in any order, or even in parallel. Further, in specific embodiments of the present invention, only one of the two steps (either 306 or 308) may be performed. For example, specific embodiments of the present invention may be configured to only check if the user is allowed to perform recall operations irrespective of the process or program that generated or caused the generation of the recall request. Alternative embodiments of the present invention may be configured to only check if a program or process is allowed to perform a recall operation irrespective of the user information. A system administrator is allowed to configure what checks are to be applied and how the checks are to be applied.

As described above, one or more exclusion lists may be used to specify users and/or programs that are not allowed to perform recall or demigration operations. According to an embodiment of the present invention, the exclusion lists may be applicable to the whole storage network or alternatively to a user-definable portion of the storage network. For example, users listed in an exclusion list may be prevented from performing recall for all the storage units or for a subset of the storage units (e.g., a particular server, group of servers, group of storage devices, groups of volumes, etc.)

In addition to using exclusion lists and/or inclusion lists, a system administrator may also use application programming interfaces (APIs) to provide exclusion information to a control program that is configured to control recall operations according to the teachings of the present invention. The exclusion information may specify users and/or programs that are not permitted to perform recall operations. The information may be at program startup time or may be provided dynamically in real-time during program execution.

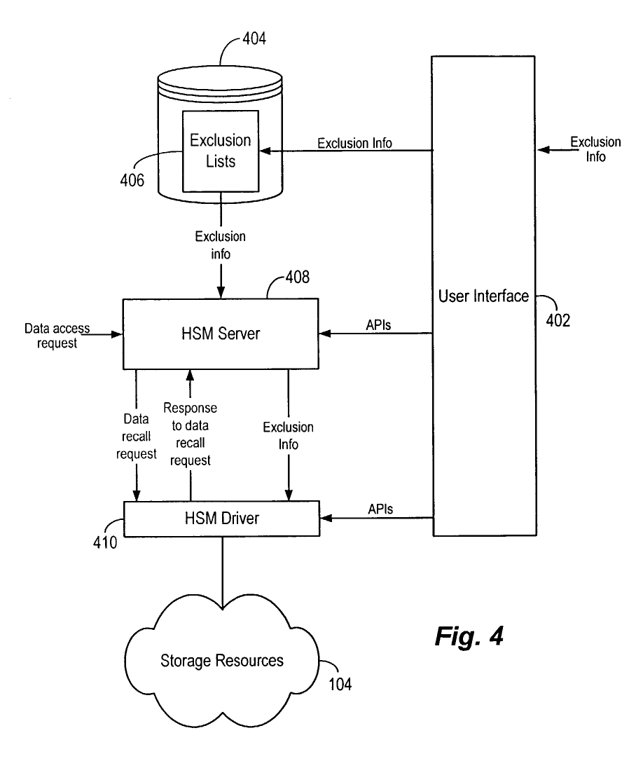

FIG. 4 is a simplified block diagram showing modules that may be used to implement an embodiment of the present invention. The modules depicted in FIG. 4 may be implemented in software, hardware, or combinations thereof. As shown in FIG. 4, the modules include a user interface module 402, a HSM server module 408, and a HSM driver module 410. A data store 404 is also provided to store data and information used by the various modules to control recall of data according to the teachings of the present invention. It should be understood that the modules depicted in FIG. 4 are merely illustrative of an embodiment of the present invention and do not limit the scope of the invention as recited in the claims. One of ordinary skill in the art would recognize other variations, modifications, and alternatives.

User interface module 402 allows a user (e.g., a storage system administrator) to control and manage the storage environment. A system administrator may provide exclusion information (e.g., information identifying users and/or programs that are not permitted to perform recall) via user interface module 402. The exclusion information may be stored in the form of exclusion lists 406 in data store 404. A storage system administrator may also manage exclusion lists 406 stored in data store 404 via user interface module 402.

An administrator may also interact with HSM server 408 and HSM driver 410 via user interface module 402. User interface module 402 may use APIs provided by HSM server 408 or HSM driver 410 to interact and communicate information with server 408 or driver 410. For example, according to an embodiment of the present invention, exclusion information provided by an administrator may be communicated to HSM server 408 or HSM driver 410 using APIs provided by HSM server 408 and/or HSM driver 410.

The exclusion information may be provided at startup time or dynamically in real time during operation of HSM server 408 or driver 410. A system administrator may also use user interface module 402 to find information about users and/or programs that are executing and making data access requests. The administrator may then dynamically instruct the data management software (e.g., HSM server application 408) to exclude one or more programs or users from performing recalls. Likewise, a user may also enable a previously excluded program or user to perform recall.

According to an embodiment of the present invention, information identifying users and/or programs that are not permitted to perform recall may be stored in the form of exclusion lists in persistent data store 404. The information may also be stored in the form of configuration files, in the Windows registry, as a Directory Services (e.g., Microsoft Active Directory, Novell eDirectory, LDAP, etc.). Information related to one or more groups may also be stored in data store 404. In alternative embodiments, data store 404 may store inclusion lists information.

HSM server 408 and HSM driver 410 are configured to perform data storage management by moving data between storage units. HSM server may be a dedicated server or any file/application server with an agent software to perform data management or automated data migration. HSM driver 410 is coupled to storage resources 104 that comprise one or more storage units. According to an embodiment of the present invention, HSM server 408 is started automatically during system startup. Upon startup, HSM server 408 reads exclusion information from one or more exclusion lists 406 stored in data store 404. The exclusion information is then forwarded by server 408 to HSM driver 410. HSM driver 410 may store the exclusion information in an internal format. As previously described, exclusion information may also be provided dynamically to HSM server 408 or to HSM driver 410 using APIs provided by server 408 or by driver 410.

According to an embodiment of the present invention, HSM server 408 is configured to receive data access requests from users and/or programs. For example, HSM server 408 may receive a request to access a particular data file from a user, a particular program, or process. In response to a data access request, HSM server 408 may generate a signal to recall the requested data. HSM server 408 may communicate the recall signal to HSM driver 410.

According to an embodiment of the present invention, HSM driver 410 is configured to reduce false recalls by controlling the users and/or programs that can perform recall operations. Upon receiving a signal to perform a recall operation from HSM server 408, HSM driver 410 determines if the user and/or program is permitted to perform the recall operation based upon exclusion information accessible to HSM driver 410. If the user and/or program are not permitted to perform the recall operation, then HSM driver 410 may communicate a response message to HSM server 408 indicating that the requested recall operation was disallowed. The response message may include information indicating a reason why the operation was disallowed. If the user or program is permitted to perform the recall operation, then HSM driver 410 may recall the requested data file. In this manner, HSM driver 410 is configured to selectively perform recall operations.

As described above, embodiments of the present invention reduce false or unnecessary recalls from occurring in a storage system by controlling the users and/or programs that can perform recall operations. Embodiments of the present invention can filter out recall requests based upon user identities and/or program identities. By disallowing recall requests received from administrator-specified users and programs, embodiments of the present invention reduce the number of false recalls performed by an automated storage management application such as an HSM application without affecting or compromising functionality. This provides significant advantages over conventional storage management systems.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. In a storage system comprising a plurality of storage units, a method of controlling recall of data, the method comprising:
receiving a signal to recall a data file, the signal generated in response to a request to access the data file received from a user;
determining if the user is permitted to recall the data file; and
disallowing recall of the data file if the user is not permitted to recall the data file.

2. The method of claim 1 wherein determining if the user is permitted to recall the data file comprises:
accessing exclusion information identifying one or more users that are not permitted to perform a recall operation; and
determining that the user is not permitted to recall the data file if the user is included in the one or more users.

3. The method of claim 2 wherein the exclusion information further comprises, for at least one user in the one or more users, information identifying a set of one or more of storage units from the plurality of storage units for which the at least one user is not permitted to perform a recall operation, wherein the plurality of storage units includes at least one storage unit that is not included in the set of storage units.

4. The method of claim 1 further comprising:
receiving exclusion information identifying one or more users that are not permitted to perform a recall operation; and
wherein determining if the user is permitted to recall the data file comprises determining that the user is not permitted to recall the data file if the user is included in the one or more users.

5. The method of claim 1 wherein the request to access the data file is received from a program, the method further comprising:
determining if the program is permitted to recall the data file; and
disallowing recall of the data file if the program is not permitted to recall the data file.

6. The method of claim 5 wherein determining if the program is permitted to recall the data file comprises:
accessing exclusion information identifying one or more programs that are not permitted to perform a recall operation; and
determining that the program is not permitted to recall the data file if the program is included in the one or more programs.

7. The method of claim 6 wherein the exclusion information further comprises, for at least one program in the one or more programs, information identifying a set of one or more of storage units from the plurality of storage units for which the at least one program is not permitted to perform a recall operation, wherein the plurality of storage units includes at least one storage unit that is not included in the set of storage units.

8. The method of claim 5 further comprising:
receiving exclusion information identifying one or more programs that are not permitted to perform a recall operation; and
wherein determining if the program is permitted to recall the data file comprises determining that the program is not permitted to recall the data file if the program is included in the one or more programs.

9. In a storage system comprising a plurality of storage units, a system for controlling recall of data, the system comprising:
a processor; and
a memory coupled to the processor, the memory configured to store a plurality of code modules for execution by the processor, the plurality of code modules comprising:
a code module for receiving a signal to recall a data file, the signal generated in response to a request to access the data file received from a user; and
a code module for determining if the user is permitted to recall the data file, the processor module configured to disallow recall of the data file if the user is not permitted to recall the data file.

10. The system of claim 9 wherein the code module for determining if the user is 4permitted to recall the data file comprises:
a code module for accessing exclusion information identifying one or more users that are not permitted to perform a recall operation; and
a code module for determining that the user is not permitted to recall the data file if the user is included in the one or more users.

11. The system of claim 10 wherein the exclusion information further comprises, for at least one user in the one or more users, information identifying a set of one or more of storage units from the plurality of storage units for which the at least one user is not permitted to perform a recall operation, wherein the plurality of storage units includes at least one storage unit that is not included in the set of storage units.

12. The system of claim 9 wherein the plurality of code modules further comprises:
a code module for receiving exclusion information identifying one or more users that are not permitted to perform a recall operation; and
wherein the code module for determining if the user is permitted to recall the data file comprises a code module for determining that the user is not permitted to recall the data file if the user is included in the one or more users.

13. The system of claim 9 wherein the request to access the data file is received from a program and wherein the plurality of code modules further comprises:
a code module for determining if the program is permitted to recall the data file; and
a code module for disallowing recall of the data file if the program is not permitted to recall the data file.

14. The system of claim 13 wherein the code module for determining if the program is permitted to recall the data file comprises:
a code module for accessing exclusion information identifying one or more programs that are not permitted to perform a recall operation; and
a code module for determining that the program is not permitted to recall the data file if the program is included in the one or more programs.

15. The system of claim 14 wherein the exclusion information further comprises, for at least one program in the one or more programs, information identifying a set of one or more of storage units from the plurality of storage units for which the at least one program is not permitted to perform a recall operation, wherein the plurality of storage units includes at least one storage unit that is not included in the set of storage units.

16. The system of claim 13 wherein the plurality of code modules further comprises:
a code module for receiving exclusion information identifying one or more programs that are not permitted to perform a recall operation; and
wherein the code module for determining if the program is permitted to recall the data file comprises a code module for determining that the program is not permitted to recall the data file if the program is included in the one or more programs.

17. A computer program product stored on a computer-readable storage medium for controlling recall of data in a storage system comprising a plurality of storage units, the computer program product comprising:
code for receiving a signal to recall a data file, the signal generated in response to a request to access the data file received from a user;
code for determining if the user is permitted to recall the data file; and
code for disallowing recall of the data file if the user is not permitted to recall the data file.

18. The computer program product of claim 17 wherein the code for determining if the user is permitted to recall the data file comprises:
code for accessing exclusion information identifying one or more users that are not permitted to perform a recall operation; and
code for determining that the user is not permitted to recall the data file if the user is included in the one or more users.

19. The computer program product of claim 18 wherein the exclusion information further comprises, for at least one user in the one or more users, information identifying a set of one or more of storage units from the plurality of storage units for which the at least one user is not permitted to perform a recall operation, wherein the plurality of storage units includes at least one storage unit that is not included in the set of storage units.

20. The computer program product of claim 17 further comprising:
code for receiving exclusion information identifying one or more users that are not permitted to perform a recall operation; and
wherein the code for determining if the user is permitted to recall the data file comprises code for determining that the user is not permitted to recall the data file if the user is included in the one or more users.

21. The computer program product of claim 17 wherein the request to access the data file is received from a program, the computer program product further comprising:
code for determining if the program is permitted to recall the data file; and
code for disallowing recall of the data file if the program is not permitted to recall the data file.

22. The computer program product of claim 21 wherein the code for determining if the program is permitted to recall the data file comprises:
code for accessing exclusion information identifying one or more programs that are not permitted to perform a recall operation; and
code for determining that the program is not permitted to recall the data file if the program is included in the one or more programs.

23. The computer program product of claim 22 wherein the exclusion information further comprises, for at least one program in the one or more programs, information identifying a set of one or more of storage units from the plurality of storage units for which the at least one program is not permitted to perform a recall operation, wherein the plurality of storage units includes at least one storage unit that is not included in the set of storage units.

24. The computer program product of claim 21 further comprising:
code for receiving exclusion information identifying one or more programs that are not permitted to perform a recall operation; and
wherein the code for determining if the program is permitted to recall the data file comprises code for determining that the program is not permitted to recall the data file if the program is included in the one or more programs.

25. In a storage system comprising a plurality of storage units, a system for controlling recall of data, the system comprising:
means for receiving a signal to recall a data file, the signal generated in response to a request to access the data file received from a user;
means for determining if the user is permitted to recall the data file; and
means for disallowing recall of the data file if the user is not permitted to recall the data file.

26. The system of claim 25 wherein the request to access the data file is received from a program, the system further comprising:
means for determining if the program is permitted to recall the data file; and
means for disallowing recall of the data file if the program is not permitted to recall the data file.
